(19) United States
(12) Patent Application Publication
(10) Pub. No.: US 2005/0010044 A1
(43) Pub. Date: Jan. 13, 2005

(54) Polysaccharides and methods and intermediates useful for their preparation

(76) Inventors: Robert J. Linhardt, Albany, NY (US); Nathalie A. Karst, Paris (FR); Tasneem Islam, San Diego, CA (US)

Correspondence Address: Schwegman, Lundberg, Woessner & Kluth, P.A., P.O. Box 2938, Minneapolis, MN, 55402, US

(21) Appl. No.: 10/874,692

(22) Filed: Jun. 23, 2004

Related U.S. Application Data
(60) Provisional application No. 60/482,960, filed on Jun. 23, 2003.

(51) Int. Cl. C08B 37/00

(52) U.S. Cl. 536/54; 536/118

(57) ABSTRACT

The invention provides sulfo-protected polysaccharides and methods for preparing sulfo-protected polysaccharides, as well as intermediate compounds useful in such methods.

### PRIORITY OF INVENTION

This application claims priority to U.S. Provisional Application No. 60/482,960, which was filed on 23 Jun. 2003.

### GOVERNMENT SUPPORT

This invention was made with United States Government support under grant number HL62244 awarded by the National Institutes of Health. The United States Government has certain rights in the invention.

### FIELD OF THE INVENTION

The invention is related to sulfo protected nitrogen-containing monosaccharides, methods of making the same, and to methods of making polysaccharides using sulfo protected monosaccharides or other polysaccharides.

### BACKGROUND OF THE INVENTION

Glycosaminoglycans (GAGs) are linear, polydisperse acidic polysaccharides that occur ubiquitously in animal tissues, membranes, intracellularly in secretory granules or extracellularly in the matrix. GAGs contain repeating units of hexosamine, either glucosamine (GlcNp) or galactosamine (GalNp), and uronic acid, either glucuronic acid (GIcAp) or iduronic acid (IdoAp). The biological significance of these sulfated oligosaccharides has made them the object of numerous studies for synthetic carbohydrate chemists for several decades. See Islam, T., Linhardt, R. J. Carbohydrate-based drug discovery, Wong, C.-H.; Ed, Wiley-VCH Verlag-GmbH, 2003, 1, 407-403 and Avci, F. Y., Karst, N., Linhardt, R. J., Current Pharmaceutical Design, 2003, 9, 2323-2335. However, due to their structural complexity, GAG synthesis has remained an important challenge.

The differential protection of functional groups of similar reactivity is a major challenge for the synthesis of complex natural products. The task of distinguishing specific hydroxyl and amino functionalities becomes particularly daunting in carbohydrate chemistry when highly branched structures call for several selectively removable masking groups. Over the years a host of protecting groups has been introduced, each making use of the unique reactivity of the particular masking moiety. Greene, T. W.; Wuts, P. G. M. Protective Groups in Organic Synthesis; John Wiley & Sons; New York, 1999. Traditionally, benzyl ethers have been employed for “permanent” protection and are removed during the late stages of the synthesis, while ester moieties and silyl ethers are used to temporarily mask hydroxyl groups to be unveiled during the synthesis. Orthogonality of protecting groups, or the ability to remove one particular masking entity without affecting the others, is a key issue for synthetic planning and experimental execution.

In oligosaccharide synthesis, the reactivity of benzyl ethers has been tuned by using substituted benzyl ether protecting groups which could be selectively removed in the presence of unsubstituted benzyl ethers. These substituted benzyl ethers were generally less stable to reaction conditions than unsubstituted benzyl ethers. Greene, T. W.; Wuts, P. G. M. Protective Groups in Organic Synthesis; John Wiley & Sons; New York, 1999, p 86-113. The 4-O-methoxy benzyl group (PMB) has found frequent applications in natural product synthesis since it can be cleaved oxidatively thus sparing most other protective groups. Greene, T. W.; Wuts, P. G. M. Protective Groups in Organic Synthesis; John Wiley & Sons; New York, 1999, p 86-91. The acid sensitivity of this group has somewhat restricted its synthetic utility. More recently, other 4-O-substituted benzyl ethers containing acetate and silyl substituents have been reported. Jobron, L.; Hindsgaul, O. J. Am. Chem. Soc. 1999, 121, 5835-5836. While these benzyl ether groups do not require palladium catalyzed hydrogenation for their removal, they necessitate treatment with base or fluoride respectively, followed by oxidative cleavage. These deprotection protocols forfeit compatibility of these 4-substituted benzyl ethers with ester, silyl, or 4-methoxybenzyl group protecting groups.

The synthesis of natural sulfated oligosaccharides and of analogues containing various modifications is not trivial since it requires extensive protection and deprotection steps. For example, in some oligosaccharides, at least three orthogonal protection groups per monosaccharide unit have to be employed in the synthesis: one for protecting the C-4 hydroxyl group, which needs to be selectively free for coupling; a second protecting group for those amino/hydroxyl groups which need to be sulfated during synthesis; and a third protecting group for those hydroxyl groups that remain free in the final product.

Selective protection and deprotection in carbohydrate synthesis continues to be a problem. To overcome the inherent difficulties and unpredictability associated with glycosylation reactions, protecting groups other than benzyl ethers have been proposed. 2,2,2-Trifluorodiazoethane has been used as a protecting group in certain specific sulfated monosaccharides, as these are key structures in biological interactions (see S. L. Flitsch, et al. “Development of a Protecting Group for Sulfate Esters,” Tetrahedron Letters, 1997, 38, 7243-7246), however, the preparation of nitrogen-containing saccharides or polysaccharides including this group or the preparation of polysaccharides from building blocks including this group has not been reported.

Not only must a protection group be stable during one set of reaction conditions, it also must be easily and cleanly removed during a different set of reaction conditions. As discussed above, one attempt to solve this problem has been to alter the properties of benzyl protecting groups, however, the search continues for protecting groups that can predictably withstand glycosylation reaction conditions. Also, as the complexity of glycosylation reactions continues to increase, protecting groups that can protect non-oxygen containing functional groups are needed. Hence, there is a need to develop synthetic methods for complex carbohydrates which minimize the use of protecting groups.

Recent advances in oligosaccharide preparation, such as automated solid phase synthesis, have shown promising results, allowing faster access to molecules of interest. See Karst, N., Linhardt, R. J., Curr. Med. Chem., 2003, 10, 1993-2031; Yeung, B. K. S., Chong, P. Y. C., Petillo, P. A., J. Carbohydr. Chem., 2002, 21, 799-865, and Hewitt, M. C., Snyder, D. A., Seeberger, P. H., J. Am.Chem. Soc. 2002, 124, 13434-13436. Nevertheless, these approaches still require preparation of suitably designed monomers. Positions that will ultimately contain sulfo groups must be masked with temporary protecting groups, deprotected after assembly of the oligosaccharide and sulfonated. Thus, such strategies require multi-step synthetic sequences and intensive protecting group manipulation. Additionally, sulfonation reactions can be troublesome and often sluggish with higher oligosaccharides. See Tamura, J. I., Neumann, K. W., Kurono, S., Ogawa, T., Carbohydr. Res., 1998, 305 and Karst, N., Jacquinet, J.-C., Eur. J. Org. Chem., 2002, 815-825.

### SUMMARY OF THE INVENTION

The present invention includes a method of protecting and deprotecting molecules with multiple hydroxyl functionalities or a combination of hydroxyl and amine functional groups using sulfo protecting groups. In one embodiment, the present invention is directed to the protection of hydroxyl or amine functional groups in monosaccharides using haloalkyl sulfates, such as 2,2,2-trifluoroethane sulfate. The introduction of protected sulfo esters, into monosaccharide or disaccharide building blocks at the early stages of polysaccharide synthesis reduces protecting group manipulation and decrease the polarity of these molecules, making them easier to handle and purify. Accordingly, the methods and compounds of the invention are useful to facilitate polysaccharide synthesis.

In one embodiment the invention provides a method of preparing a sulfo-protected polysaccharide comprising reacting at least one saccharide with at least one other saccharide having a hydroxyl or amine protected with a haloalkyl sulfonyl group to form the sulfo-protected polysaccharide

The invention also provides a method of preparing a sulfo-protected polysaccharide comprising reacting at least one monosaccharide with at least one other monosaccharide having a hydroxyl or amine protected with a haloalkyl sulfonyl group to form the sulfo-protected polysaccharide.

The invention also provides a compound comprising a nitrogen-containing monosaccharide having at least one hydroxyl or amine functional group protected by a haloalkyl sulfonyl group.

The invention also provides a polysaccharide comprising at least one haloalkyl sulfonyl group.

The present invention also encompasses glycosylation reactions using monosaccharides protected with haloalkyl sulfates (e.g. 2,2,2-trifluoroethane sulfates). The glycosylation reactions form polysaccharides, wherein at least one hydroxyl or amine functional group is protected with a haloalkyl sulfonyl residue (e.g. a 2,2,2-trifluoroethane sulfonyl residue). In one embodiment of the invention, a monosaccharides protected with a haloalkyl group (e.g. a group generated from 2,2,2-trifluorodiazoethane) can be used in combinatorial libraries or automated glycosylation reactions.

Nitrogen containing saccharides can be particularly difficult to prepare due to the presence of the reactive nitrogen. In one aspect the invention provides a method for preparing sulfo-protected nitrogen-containing saccharides. This method is particularly useful for preparing nitrogen-containing saccharide building blocks that can be used to prepare glycosaminoglycans. The invention also provides novel sulfo-protected nitrogen-containing mono and polysaccharides.

The invention also provides novel intermediate compounds and synthetic processes that are disclosed herein, for example, the compounds and processes illustrated in the Figures and Tables herein.

### BRIEF DESCRIPTION OF THE FIGURES

FIGS. 1-17 Illustrate the preparation of compounds of the invention as described in detail in the Examples below.

### DETAILED DESCRIPTION OF THE INVENTION

As used herein the term “protecting group” refers to any group which, when bound to one or more hydroxyl, thiol, amino, carboxy or other groups, prevents undesired reactions from occurring at these groups and which protecting group can be removed by conventional chemical or enzymatic steps to reestablish the hydroxyl, thio, amino, carboxy, or other group. The particular removable blocking group employed is not critical and preferred removable hydroxyl blocking groups include conventional substituents such as allyl, benzyl, acetyl, chloroacetyl, thiobenzyl, benzylidine, phenacyl, t-butyl-diphenylsilyl and any other group that can be introduced chemically onto a hydroxyl functionality and later selectively removed either by chemical or enzymatic methods in mild conditions compatible with the nature of the product. Protecting groups are disclosed in more detail in T. W. Greene and P. G. M. Wuts, “Protective Groups in Organic Synthesis” 3rd Ed., 1999, John Wiley and Sons, N.Y.

As used herein, the term “amino-containing monosaccharide” refers to a monosaccharide having at least one amino functional group. For example, amino-containing monosaccharides include, but are not limited to, L-vancosamine, 3-desmethyl-vancosamine, 3-epi-vancosamine, 4-epi-vancosamine, acosamine, actinosamine, daunosamine, 3-epi-daunosamine, ristosamine, and N-methyl-D-glucamine, D-glucosamine, and D-galactosamine.

As used herein, the term “nitrogen-containing monosaccharide” refers to a monosaccharide having at least one nitrogen containing functional group including, but not limited to, amine, nitro, azide, amide, and the like. The term includes amino-containing monosaccharides.

As used herein, the term “amino-containing saccharide” refers to a monosaccharide or polysaccharide having at least one amino functional group.

As used herein, the term “nitrogen-containing saccharide” refers to a monosaccharide or polysaccharide having at least one nitrogen containing functional group including, but not limited to an amine, a nitro group, an azide, an amide, and the like. The term includes nitrogen-containing monosaccharides.

As used herein, the term “polysaccharides” includes saccharides having more than one monosaccharide residue, including, disaccharides, oligosaccharides, and polysaccharides.

The present invention encompasses methods of protecting and deprotecting nitrogen-containing monosaccharides having multiple hydroxyl groups using haloalkyldiazo sulfates (e.g. 2,2,2-trifluorodiazoethane sulfate). Another embodiment of the invention encompasses methods of protecting and deprotecting monosaccharides having multiple hydroxyl groups and at least one amine functional group using haloalkyldiazo sulfates (e.g. 2,2,2-trifluorodiazoethane sulfate). The invention also encompasses glycosylation reactions using monosaccharides wherein at least one monosaccharide has at least one hydroxyl or amine group which is protected with a haloalkyl sulfates (e.g. 2,2,2-trifluorodiazoethane sulfate).

The present invention also encompasses using a compound having multiply protected hydroxyl functionalities, protected amine functionalities, or combinations thereof in glycosylation reactions to form disaccharides, oligosaccharides, or polysaccharides wherein at least one sulfo substituted hydroxyl or amine functional group is protected as a haloalkylsulfate (e.g. a 2,2,2-trifluoroethane sulfate).

Compounds having multiple hydroxyl or amine functionalities or a combination thereof contemplated by the invention includes, but are not limited to, monosaccharides, disaccharides, oligosaccharides, polysaccharides, deoxy derivatives thereof, amino-containing monosaccharides, or mixtures thereof. In particular, the compounds of the invention include monosaccharide units having a variety of hydroxyl functional groups or amino-containing monosaccharide, wherein at least one hydroxyl or amine functional group is protected with a protecting group other than 2,2,2-trifluoroethylsulfate. Monosaccharides contemplated in the invention, include, but are not limited to, allose, altrose, arabinose, erythose, fructose, galactose, glucose, gulose, idose, lyxose, mannose, ribose, ribulose, tagatose, talose, threose, xylose, vancosamine, 3-desmethyl-vancosamine, 3-epi-vancosamine, 4-epi-vancosamine, acosamine, actinosamine, daunosamine, 3-epi-daunosamine, ristosamine, glucamine, N-methyl-glucamine, glucuronic acid, glucosamine, galactosamine, sialyic acid, iduronic acid, L-fucose, ribulose, sucrose, lactose, maltose, and the like. Also contemplated within the invention, are monosaccharide derivatives such as acetals, amines, azides, and carboxylic acids, as well as acylated, sulfated, phosphorylated, and deoxy derivatives. Deoxy derivatives include, but are not limited to, 6-deoxygalactose (fucose), 6-deoxy-mannose (rhamnose), and the like.

The monosaccharides can be protected using protecting groups commonly known to one skilled in the art. However, at least one hydroxyl functional group or amine functional group should be available to be protected with a haloalkyl sulfate (e.g., 2,2,2-trifluoroethane sulfate).

Typically, the hydroxyl or amine functional group is sulfonated and either simultaneously or sequentially alkylated with a halogenated alkyl group. In other words, the hydroxyl or amine functional group can be first sulfonated, optionally isolated and purified, and thereafter allowed to react to form the haloalkylsulfate (e.g. with a haloalkyl diazo compound). In one embodiment, the haloalkyl sulfate compound of the invention includes a 2,2,2-trifluoroethane sulfate.

One method of the invention comprises, sulfonating a nitrogen-containing monosaccharide having multiple hydroxyl and/or amine functional groups to form a sulfonated monosaccharide. Thereafter, the sulfonated monosaccharide is allowed to react with a haloalkyl diazo compound under mild acidic conditions at a suitable temperature and for a suitable time to obtain a haloalkyl sulfonated protected monosaccharide.

One of ordinary skill in the art with little or no experimentation can easily determine the appropriate reaction conditions to sulfonate a hydroxyl or amine group. Typically, the monosaccharide is multiply protected using hydroxyl protecting groups and techniques commonly known to one skilled in the art. See, Greene T. W.; Wuts, P. G. M., Protective Groups in Organic Synthesis; John Wiley & Sons; New York 1999. Typically, an unprotected functional group (e.g. a hydroxyl or amine group) within the monosaccharide is allowed to react with a sulfonating compound, i.e. a compound capable of placing a SO₃ functional group onto the hydroxyl or amine functional group. The sulfonation can be carried out by reacting a monosaccharide with Me₃NSO₃, and a suitable solvent, such as dimethylforamide (DMF) or an alternative sulfonating reagent such as SO₃-pyridine complex in DMF. Once the monosaccharide has been sulfonated, the sulfonated product can be allowed to react with a haloalkyl diazo compound (e.g. CF₃CH₂N₂) and a mild acid, in a suitable solvent for a suitable time at a suitable temperature to obtain the amine or hydroxyl group bonded to a haloalkylsulfonyl group(e.g. SO₃CH₂CF₃). While CF₃CH₂N₂ is preferred in this reaction, the diazonium salts of other halohydrocarbons (e.g. fluorinated hydrocarbons) can be used in place of CF₃CH₂N₂. One of ordinary skill in the art can easily synthesize CF₃CH₂N₂ and other haloalkyl diazo compounds using procedures similar to those described by C. O. Hesse, Synthesis, 1984, 1041-1042.

Acids suitable for use according to the methods of the invention include, but are not limited to, compounds having a carboxylic acid functional group, such as, citric acid and acetic acid. In one embodiment of the invention a preferred acid is citric acid.

Solvents used in the method of the invention include, but are not limited to, mildly polar solvents such as acetonitrile, dichloromethane, tetrahydrofuran, and diethylether. The time suitable to conduct the protection step of the method of the invention, will depend upon the amount of reactants, temperature, mixing rate, and a number of other variables commonly known to the skilled artisan.

As used herein, the term halo includes fluoro, chloro, bromo, and iodo. In one preferred embodiment of the invention, halo is fluoro. The term haloalkyl includes saturated and unsaturated branched or unbranched hydrocarbon chains wherein one or more hydrogens of the hydrocarbon chain has been replaced with a halogen. The unsaturated chains can include one or more double or triple bonds. In one preferred embodiment of the invention, the haloalkyl group comprises 1, 2, 3, 4, 5, or 6 carbon atoms. In another preferred embodiment, the haloalkyl group comprises a saturated chain having 1, 2, 3, 4, 5, or 6 carbon atoms. In another preferred embodiment, the haloalkyl group comprises a saturated straight chain wherein one or more (e.g., 1, 2, 3, or 4) hydrogens (e.g., 1, 2, 3, or 4) has been replaced with fluoro or chloro. In another preferred embodiment, the haloalkyl group comprises a saturated straight chain wherein one or more (e.g., 1, 2, 3, or 4) hydrogens has been replaced with fluoro.

The methods of the invention can also ooptionally include subsequent reactions of the sulfo protected saccharides including removing the halogenated alkyl (e.g. CF₃CH₂—), to form the corresponding sulfonated saccharides; removing the halogenated alkyl sulfo protecting group (e.g., CF₃CH₂SO₃—), to provide the free hydroxyl or amine functional group; or further reacting with other mono or polysaccharides in glycosylation reactions to provide polysaccharides. The invention also provides methods comprising such subsequent reaction steps and the products of such methods.

The sulfo protected monosaccharides of the invention can be used in glycosylation reactions to form polysaccharides. The sulfo protected monosaccharides can also be used in the preparation of combinatorial libraries or in automated glycosylation reactions such as those disclosed in U.S. Pat. No. 6,579,725. Additionally, the products of glycosylation can be further reacted with other protected monosaccharides until a polysaccharides of desired length and composition is obtained, including multiply sulfonated polysaccharides.

The sulfo protected monosaccharides of the invention can be used as building blocks in the preparation of glycosaminoglycans, such as, for example, chondroitin sulfate which is useful as a supplement against osteoarthritis and in neurite outgrowth promotion, dermatan sulfate which has useful antithrombotic activity and is used in preparation of artificial tissues, heparan oligosaccharides which have useful antithrombotic activity, useful anti-inflammatory activity and useful antiatherosclerotic activity, and hyaluronic acid which is useful as a biomaterial for ophthalmic use and is useful in the treatment of osteoarthritis.

In one preferred embodiment, the monosaccharide or polysaccharide of the invention is isolated and purified. The term “isolated and purified” means that the compound is substantially free from biological materials (e.g. blood, tissue, cells, etc.). In one specific embodiment of the invention, the term means that the compound or conjugate of the invention is at least about 50 wt. % free from biological materials; in another specific embodiment, the term means that the compound or conjugate of the invention is at least about 75 wt. % free from biological materials; in another specific embodiment, the term means that the compound or conjugate of the invention is at least about 90 wt. % free from biological materials; and in another embodiment, the term means that the compound or conjugate of the invention is at least about 99 wt. % free from biological materials. In another specific embodiment, the invention provides a compound of the invention that has been synthetically prepared.

In one embodiment the invention provides a sulfo protected monosaccharide as illustrated in the Figures herein, for example, a compound of formula 11, 13, 14, 18, 19, 23, 26, 28, 30, 32, 33-52, 57-60, 62, 63, 67, or 69. The invention also provides methods for preparing such compounds that are described herein.

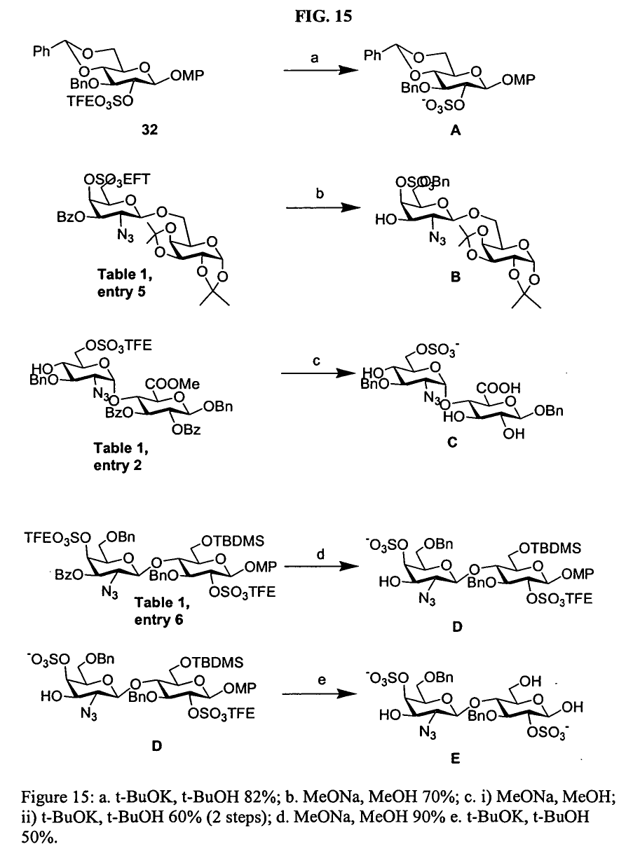

In another embodiment the invention provides a sulfo protected polysaccharide as illustrated in the Figures herein, for example, a compound of Formula 74-84, or a compound of formula A-E (FIG. 15). The invention also provides methods for preparing such compounds that are described herein.

The invention is further defined by reference to the following examples describing the preparation of the sulfo protected monosaccharides of the invention. It will be apparent to those skilled in the art, that many modifications, both to materials and methods, may be practiced without departing from the purpose and interest of this invention.

### EXAMPLES

### Example 1

General Procedure for Preparing Representative Protected Saccharides of the Invention

In a typical experimental procedure, 200 mg of saccharide in 3 mL of acetonitrile are reacted with 10 mL of a CF₃CH₂N₂ solution in acetonitrile (prepared from 1.8 g of trifluoroethylamine hydrochloride and 1 g of nitric acid) and 1 g of citric acid (This reagent should be considered as potentially explosive and highly toxic). The reaction is stirred at room temperature until completion. The solids are then filtered through a pad of celite and the filtrate is evaporated under reduced pressure. The residue is diluted with methylene dichloride, washed subsequently with water, a saturated solution of sodium bicarbonate and water, dried over magnesium sulfate, filtered and concentrated. Purification by silica gel chromatography afforded the expected product.

### Examples 2-7

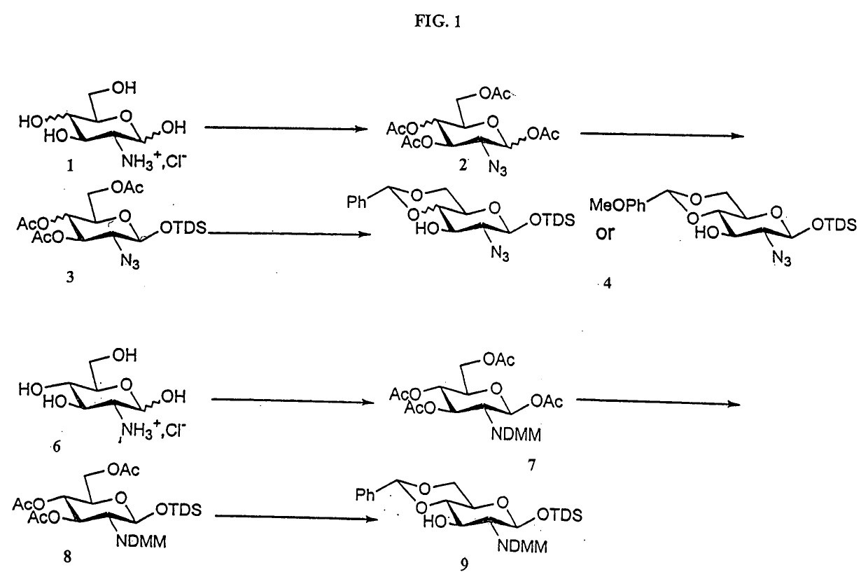

FIGS. 1 through 6 illustrate methods for preparing sulfo protected target molecules that can be used in the synthesis of glycosaminoglycans.

### Example 2

Preparation of Saccharide Intermediate

As illustrated in FIG. 1 azidonitration of the hydrochloride salt 1 of glucosamine (GlcN) or galactosamine (GalN) with TfN₃ in methanol/methylene chloride followed by peracetylation with Ac₂O in pyridine afforded the peracetylated 2 azido gluco and galacto azido sugars in 87% and 76% yields, respectively. Removal of the anomeric acetate with hydrazine-acetic acid in dimethylformamide, and silylation with TDSC1/imidazole in dimethylformamide afforded the C1 OTDS protected gluco and galacto derivative 3 in 74% and 65% yields, respectively. Subsequent deacetylation with MeO⁻Na⁺methanol, 4,6 benzylidination with PhCH(OMe)₂, camphorsulfonic acid in acetonitrile afforded the gluco and galacto series target molecules 4 with unprotected 3-hydroxyl groups in 79% and 78% yields, respectively.

### Example 3

Preparation of Saccharide Intermediate

Also illustrated in FIG. 1, the dimethylmaleloyl protected GlcN was prepared starting from the hydrochloride salt of glucosamine 6. N-protection using dimethylmaleloyl anhydride-triethylamine in methanol, followed by peracetylation with Ac₂O in pyridine afforded DMM protected, peracetylated GlcN 7 in 38% yield. C1 deprotection with hydrazine acetic acid in dimethylformamide and TDS protection with TDSC1-imidazole in dimethylformamide resulted in 84% yield of compound 8. Deacetylation with MeO⁻Na⁺ in methanol and benzylidination with PhCH(OMe)₂ camphorsulfonic acid in methanol afforded the differentially O-protected dimethylmaleloyl GlcN 9 having a single free 3-hydroxyl group in 85% yield.

### Example 4

Preparation of Representative Protected Saccharide of the Invention

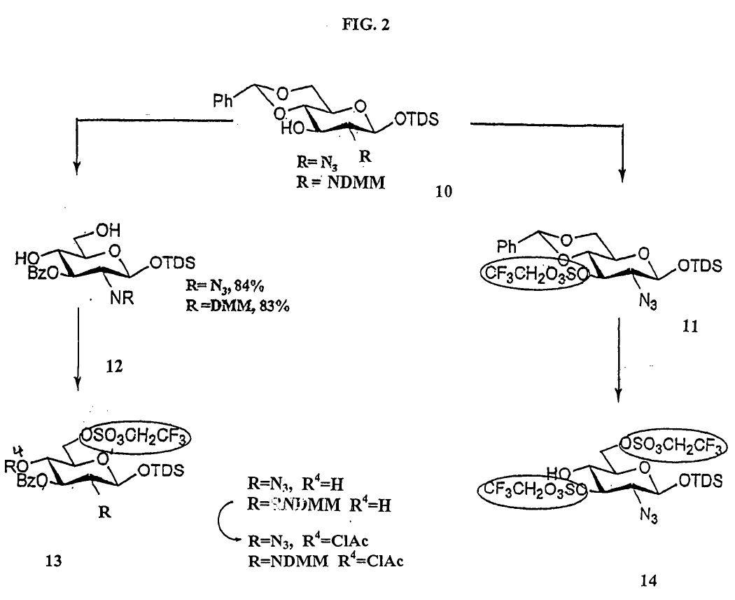

In FIG. 2 there is shown the introduction of glucosamine derivatives with trifluoroethylsulfate groups in the 6-,4- and 4,6-positions. Beginning with the 1-TDS, 2-azido or 2-N-dimethylmaleloyl, 4,6-benzylidine GlcN, compound 10 the 3-hydroxyl group was 3-benzoylated with BzC1 in pyridine and treated with EtSH, p-TsOH in methylene chloride to give the 3-Bz protected derivatives 12. 6-O-Sulfonation of compound 12 with Me₃NSO₃ in dimethylformamide followed by sulfo protection with CF₃CH₂N₂-citric acid in acetonitrile afforded the 6-trifluroethyl sulfonated derivatives 13 that could be 4-chloroacetylated with ClAc₂O, pyridine in methylene chloride. In preparing the azido derivative 13 the monosaccharide sulfo ester (500 mg) in solution in acetonitrile (5 mL) was treated with a fresh solution of 2,2,2-trifluorodiazoethane (40 mL) prepared by means known in the literature. Citric acid (2 g) was added and the reaction mixture was stirred at room temperature until TLC analysis showed complete consumption of the starting material (1-2 days). The solution was filtered over Celite and concentrated. The residue dissolved in dichloromethane, was washed successively with water, saturated solution of sodium bicarbonate, water, dried (magnesium sulfate), filtered and concentrated. The product was purified by silica gel chromatography.

### Example 5

Preparation of Representative Protected Saccharides of the Invention

In FIG. 2 there is also shown the introduction of glucosamine derivatives with trifluoroethylsulfate groups in the 6-,4- and 4,6-positions. Beginning with the 1TDS, 2-azido or 2-N-dimethylmaleloyl, 4,6-benzylidine GlcN, compound 10 the 3-hydroxyl group was sulfonated with Me₃NSO₃ in dimethylformamide and trifluoroethyl protected with CF₃CH₂N₂-citric acid in acetonitrile to afford the 3-trifluoroethylsulfated 2-azido gluco derivative 11 in 88% yield. Benzylidine deprotection of the 3-trifluoroethylsulfated 2-azido gluco derivative 11 with EtSH, p-TSOH in methylene chloride, 6-sulfonation with Me₃NSO₃ in methylene chloride and sulfo protection with CF₃CH₂N₂-citric acid in acetonitrile afforded the 3,6 trifluoroethylsulfated 2-azido gluco derivative 13 in 50% yield.

### Example 6

Preparation of Representative Protected Saccharides of the Invention

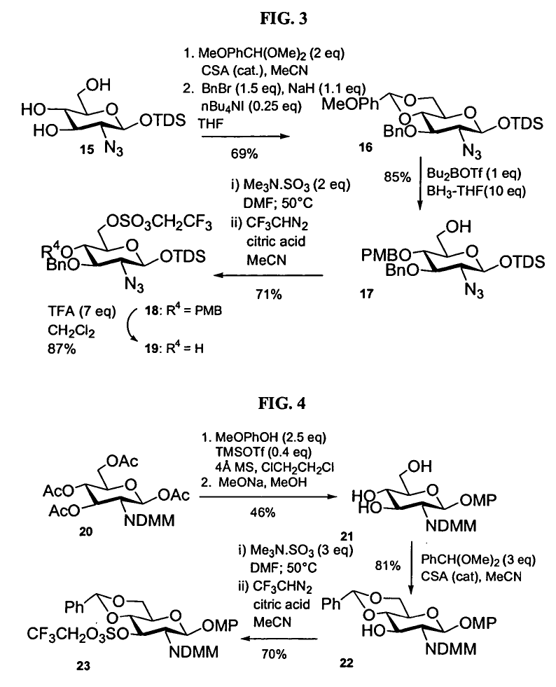

Monosaccharide building block 18 with ether protecting groups was synthesized as shown in FIG. 3. Introduction of the p-methoxy benzylidene at the 4,6-position of 15 was followed by benzylation at the 3-position to give 16. Treatment of 16 with dibutylborane triflate and 1M borane solution in THF, according to the procedure of Jiang, L, Chan, T.-H, Tetrahedron Lett., 1998 , 39, 355-358, regioselectively opened the benzylidene ring and provided compound 17 in good yield and stereoselectivity. The remaining free 6-position was sulfonated and sulfo-protected to afford building block 18 in 71% overall yield. The p-methoxybenzyl could later be selectively removed, under acidic conditions, to give access to glycosylation acceptor 19.

### Example 7

Preparation of Representative Protected Saccharides of the Invention

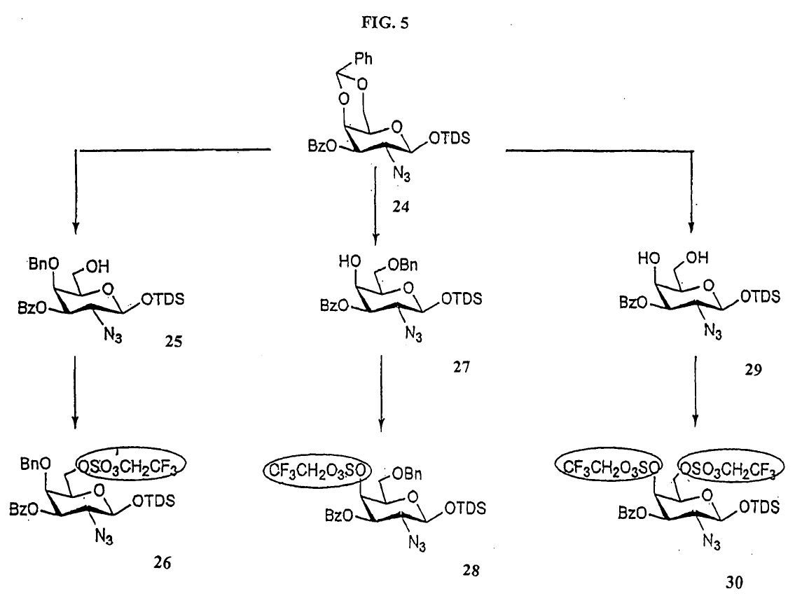

As shown in FIG. 4 D-glucosamine hydrochloride was used to prepare 1,3,4,6-O-acetyl-2-deoxy-2-dimethylmaleimido B-D-glucopyranoside 20, which was treated with p-methoxyphenol in the presence of catalytic trifluoromethanesulfonic acid and transesterified to afford β-MP derivative 21. Benzylidenation, leaving the 3-position differentiated, was followed by sulfonation and sulfo-protection to afford derivative 23 in 70% overall yield. No side-products were detected during these reactions and both the MP and DMM protecting groups were stable under the reaction conditions.

### Example 8

Preparation of Representative Protected Saccharides of the Invention

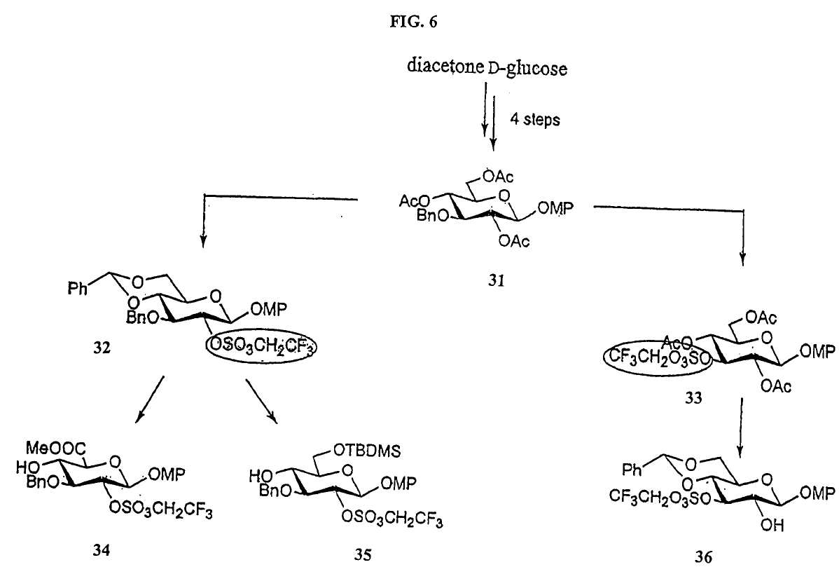

The 6-, 4- and 4,6-trifluoroethyl sulfate, 2-azido galacto derivatives shown in FIG. 5 were synthesized from 1-TDS, 2-azido, 3-benzoyl, 4,5-benzylidine galacto starting materials. Treatment of the galacto starting material 24 with Et₃SiH, PhBCl₂ in methylene chloride in the presence of 4 Å molecular sieves at −78° C. results in exposure of the 6-hydroxyl group, compound 25, in 64% yield. Sulfonation with Me₃NSO₃ in dimethylformamide and sulfo protection with CF₃CH₂N₂-citric acid and acetonitrile afforded the 6-trifluoroethyl sulfate derivative 26 in 66% yields.

### Example 9

Preparation of Representative Protected Saccharides of the Invention

As illustrated in FIG. 5, treatment of the galacto starting material 24 with Et₃SiH, TfOH in methylene chloride in the presence of 4 Å molecular sieves at −78° C. exposes the 4-hydroxyl group, compound 27, in 57% yield, subsequent sulfonation with MeNSO₃ in acetonitrile afforded the 4-trifluoroethylsulfate derivative 28 in 70% yield.

### Example 10

Preparation of Representative Protected Saccharides of the Invention

As illustrated in FIG. 5, treatment of the galacto starting material 24 with EtSH, p-TSOH in methylene chloride exposes the 4- and 6-hydroxyl groups, compound 29, in 77% yield. Sulfonation with Me₃NSO₃ in dimethylformamide and sulfo protection with CF₃CH₂N₂-citric acid in acetonitrile afforded the 4,6-trifluoroethylsulfate derivate 30 in 38% yield.

### Example 11

Preparation of Representative Protected Saccharides of the Invention

FIG. 6 shows the synthesis of the 2-sulfo protected glucuronic acid derivative 34, the 2-sulfo protected glucose derivative 35, and the 3-sulfo protected gluco derivative 36. Starting with commercially available diisopropylidene D-glucose, the 3-benzyl, 1-OMP, 2,4,6-tri-O-acetyl glucose 31 was synthesized in four steps using standard chemical methods. From this MP glycoside starting material all three sulfo protected compounds were synthesized. Deacetylation of this MP glycoside starting material with MeO⁻Na⁺, methanol, followed by benzylidenation using PhCH(OMe)₂, camphorsulfonic acid in acetonitrile, 2-sulfonation with Me₃NSO₃ in dimethylformamide and sulfoprotection with CF₃CH₂N₂-citric acid in acetonitrile afforded the 2-sulfo protected gluco derivative 32 in 87% yield. Debenzylidenation with EtSH, p-TSOH in methylene chloride, followed by oxidation of the 6-position with Ca(OC )₂, TEMPO, KBr in acetonitrile afforded the 2-sulfo protected glucuronic acid derivative 34. Debenzylidenation of compound 32 with EtSH, pTSOH in methylene chloride followed by 6-TBDMS protection with TBDMSC1, imidazole in dimethylformamide afforded the 2-sulfo protected gluco derivative 35 with a free hydroxyl group. Hydrogenation of the MP glycoside starting material 31 with H₂ over Pd/C in methanol removes the 3-O-Bn group. Subsequent 3-O-sulfonation with Me₃NSO₃ in dimethylformamide and sulfo protection with CF₃CH₂N₂-citric acid in acetonitrile afforded the 3-sulfo protected gluco derivative 33. Treatment of 33 with acetylchloride in methanol followed by benzylidenation with PhCH(OMe)₂ and camphorsulfonic acid in acetonitrile afforded the 3-sulfo protected, 2-hydroxyl gluco derivative 36.

### Example 12

Preparation of Representative Protected Saccharides of the Invention

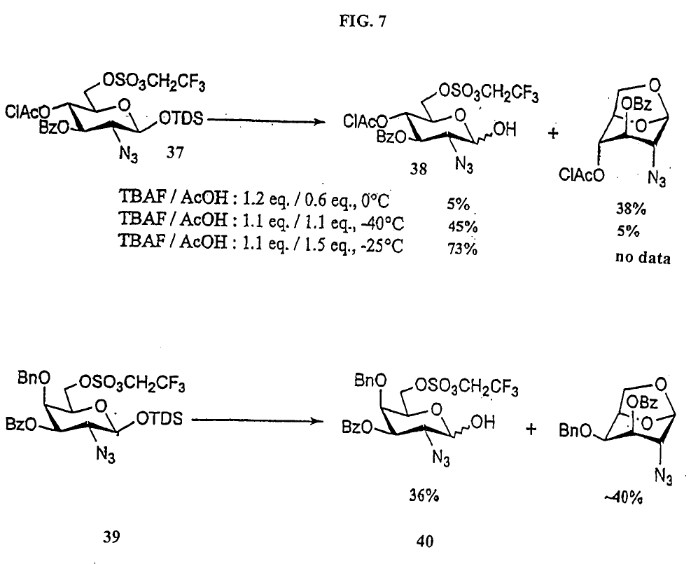

FIG. 7 shows the anomeric deprotection of the 2-azidoglucose and 2-azidogalactose series. The TDS anomeric protecting group of the 6-sulfo protected, hydroxyl protected, 2-azidoglucose 37 was removed using, for example, tributylammonium fluoride (TBAF)/acetic acid at molar ratios ranging from 2 to 1 to 1 to 1.4 in tetrahydrofuran and at temperatures ranging from −40° C. to 0° C. resulting in a 5% to 73% yield of C1 deprotected product 38.

### Example 13

Preparation of Representative Protected Saccharides of the Invention

Also as illustrated in FIG. 7, the TDS anomeric protecting group of the 6-sulfo protected, hydroxyl protected 2-azido galactose 39 was removed with TBAF/acetic acid at −40° C. in 36% yield of product 40.

### Example 14

Preparation of Representative Protected Saccharides of the Invention

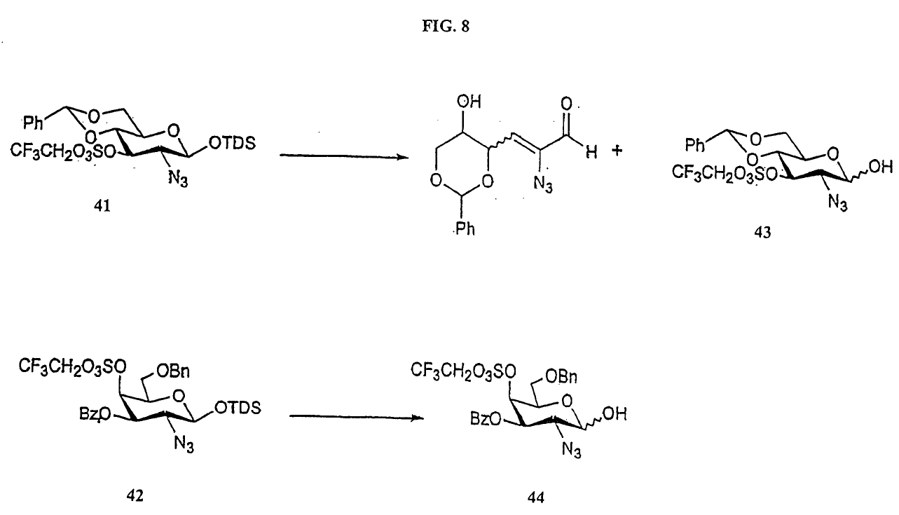

In FIG. 8 there is shown the anomeric deprotection of the 2-azidoglucose 41 series having 3-sulfo protection. Removal of anomeric TDS group from the 3-sulfo protected 2-azidoglucose series was accomplished using TBAF/acetic acid in tetrahydrofuran at −40° C. giving the C1 deprotected product 43.

### Example 15

Preparation of Representative Protected Saccharides of the Invention

Also in FIG. 8 there is shown the anomeric deprotection of the 2-azidogalactose 42 series with 4-sulfo protection. Removal of anomeric TDS from the 4-sulfo protected 2-azido galactose series using TBAF/acetic acid in tetrahydrofuran at −40° C. afforded product 44 with an anomeric hydroxyl group in 85% yield.

### Example 16

Preparation of Representative Protected Saccharides of the Invention

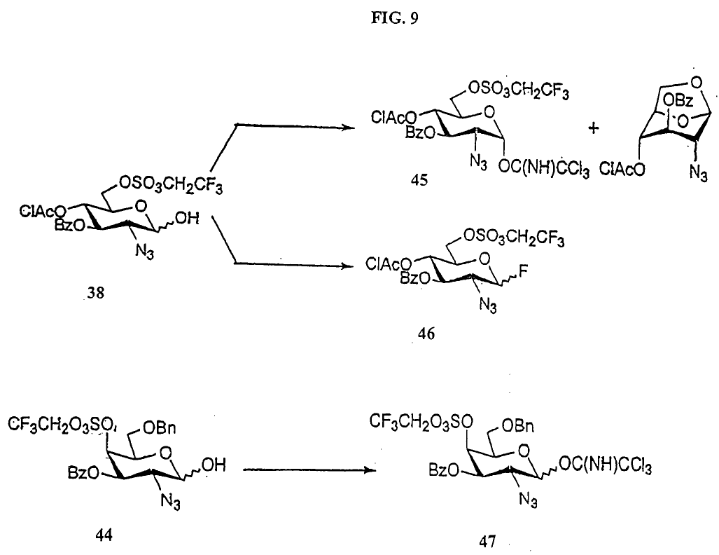

FIG. 9 shows the activation of the 6-sulfo protected hydroxyl protected 2-azidogalactose series. Treatment with trichloroacetonitrile/DBU in methylene chloride at 0° C. afforded the α-trichloroacetimidate donor 45, while treatment with DAST in methylene chloride at −30° C. afforded the donor as a 17:73 mixture of α:β fluorides 46. Treatment of the 4-sulfo protected, hydroxyl protected 2-azido galactose 44 having a free anomeric hydroxyl group with trichloroacetonitrile/DBU in methylene chloride afforded a 56:12 mixture of α:β trichloroacetimidate donors 47.

### Example 17

Preparation of Representative Protected Saccharides of the Invention

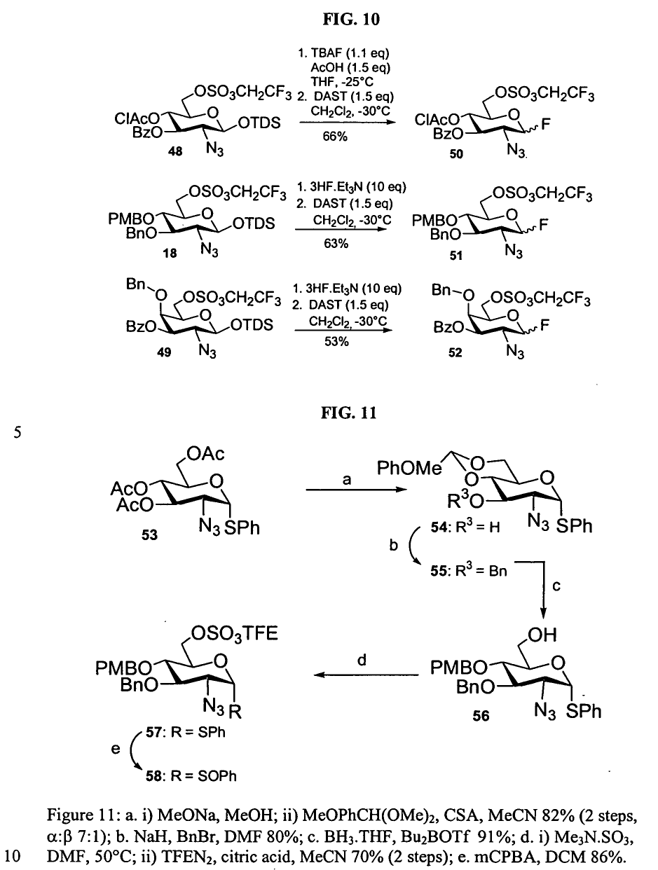

Other reactions to activate the anomeric position and preparation of glycosyl donors are shown in FIG. 10. Selective removal of TDS (thexyldimethylsilyl) group was found to be more troublesome than expected. The trifluoroethylsulfate group, when present at the 6-position, acted as a good leaving group under basic conditions in both GlcN and GaIN series and the corresponding 1,6-anhydro sugars were recovered as side-products. When excess acetic acid was added to tetrabutylammonium fluoride, in the case of compound 48, or a milder reagent such as trihydrofluoride triethylamine was used, the corresponding hemiacetals could be obtained in good yields. Activation of the 6-trifluoroethylsulfate hemiacetals under basic conditions to prepare trichloroacetimidates also led to partial loss of sulfo-protecting group. Milder bases such as cesium carbonate did not afford the trichloroacetimidates. Halogens, including fluoride, were easily introduced at the anomeric position of 6-sulfo-protected derivatives. Treatment of the hemiacetals with dimethylammonium sulfur trifluoride afforded the corresponding fluorides 50, 51, and 52 in good yield.

### Example 18

Preparation of Representative Protected Saccharides of the Invention

Other activation reactions are illustrated in FIG. 11. In the GlcNp series (FIG. 11), the α-thiophenylglycosyl donor 57 was synthesized since it could either be directly used in glycosylation or transformed into a more reactive sulfoxide donor 58. Differentially protected thiophenylglycoside 57 was synthesized from the known thiophenylglycoside 53 (Yan, L., Kahne, D., J. Am. Chem. Soc., 1996,118, 9239-9248). After deacetylation and introduction of a p-methoxybenzylidene acetal at the 4,6-positions, the remaining 3-hydroxyl was benzylated, to give 55 in 80% yield. Regioselective opening of the benzylidene acetal by treatment with Et₃SiH/Bu₂BOTf (Jiang, L., Chan, t.-H., Tetrahedron Lett., 1998, 39, 355-358) afforded the expected 6-hydroxyl derivative 56 in 91% yield. Selectivity was confirmed by NMR studies and subsequent acetylation of the primary position. Introduction of SO₃TFE at the 6-position was achieved in two steps, sulfonation and sulfo protection with a freshly prepared solution of trifluorodiazoethane in presence of citric acid, affording donor 57 in 70% yield (TFE =2,2,2-trifluoroethyl). Subsequent oxidation of 57 with mCPBA afforded the corresponding sulfoxide donor 58.

### Example 19

Preparation of Representative Protected Saccharides of the Invention

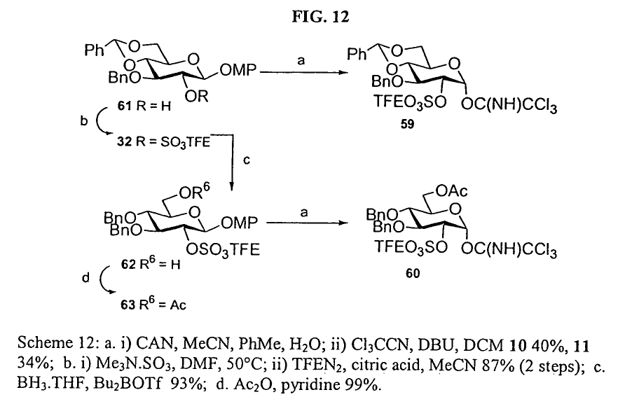

In FIG. 12 is shown the preparation of the 2-sulfo protected uronic acid precursors glucose (Glcp). 2-SO₃TFE Protected Glcp derivatives 59 and 60 were prepared (TFE =2,2,2-trifluoroethyl). The common intermediate 61 was synthesized from commercially available 1,2:5,6-di-O-isopropylidene-α-D-glucofuranose as described in literature, (Karst, N., Jacquinet, J.-C., J. Chem. Soc., Perkin Trans I, 2000, 2709-2717), and submitted to the two steps sequence of sulfonation/sulfo-protection, affording compound 32 in 87% yield. Regioselective opening of the benzylidene ring in 32 afforded 62 (93%), which was subsequently 6-O-acetylated to give compound 63. The activation of 32 and 63 proved to be troublesome and in both cases imidates 59 and 60 were obtained in 40% and 34% yield, respectively. The limiting step of activation was found to be the oxidative removal of the MP group with CAN. NMR studies of the major side-product recovered from the reaction revealed the presence of SO₃TFE group, which withstood the oxidative conditions of the reaction, and showed perturbation of the MP aromatic signals.

### Example 20

Illustration of Glycosylation Reaction with a Representative Protected Saccharide of the Invention

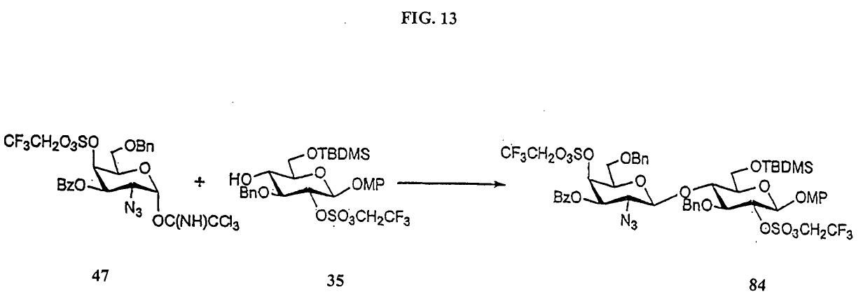

FIG. 13 shows the glycosylation of a 2-sulfo protected, hydroxyl protected glucose acceptor 35 having a single 4-free hydroxyl group with a 4-sulfo protected, hydroxyl protected, 2-azido galactose trichloroacetimidate donor 47 using boron trifluoride-etherate catalyst in toluene in the presence of 4 Å molecular sieves. Using 1.5 equivalents of donor, 1 equivalent of acceptor, 20% catalyst at −20° C. an 11% yield of β-linked disaccharide product was obtained.

### Example 21

Preparation of Representative Protected Saccharides of the Invention

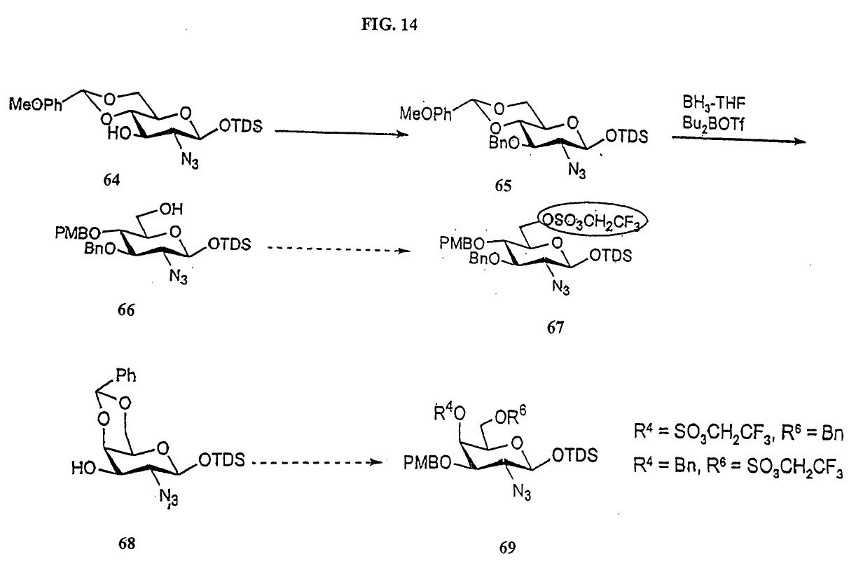

The reaction described in Example 20 was sluggish, so to improve yields new activated donors were designed having ether-protected hydroxyl groups as shown in FIG. 14. In the case of 2-azido glucose 64 the anomeric position was protected with TDS and the 4,6-position as a p-methoxybenzilidene. The free 3-hydroxyl group could be benzylated in 77% yield with benzyl bromide, sodium hydride in tetrahydrofuran containing tetrabutyl ammonium iodide to give product 65. A similar strategy is shown for the 2-azidogalactose series. In addition to being more activated donors, these compounds, 67 and 69, present protecting groups that can be cleaved under neutral or acidic conditions, thus avoiding displacement of the trifluoroethylsulfate moiety.

### Example 22

Illustration of Glycosylation Reactions with Representative Protected Saccharides of the Invention

Table 1 summarizes additional glycosylation syntheses using donors 51, 52, 47, 57, 59, and 60 and acceptors, 70, 71, 35, 72, and 73. Acceptors 70-73 have the following structures.

TABLE 1

| | |
|---|---|
| 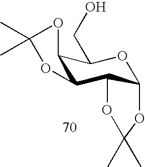 | 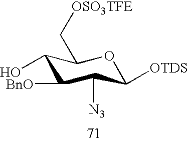 |
| 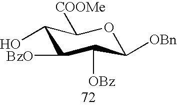 | 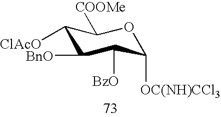 |

Glycosylation of SO₃TFE donors and acceptors.

| | | | | | yield, |
|---|---|---|---|---|---|
| en- | | | | promoter | α:β |
| try | donor | acceptor | Disaccharide | (equiv.) | ratio |
| 1 | 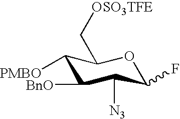 | 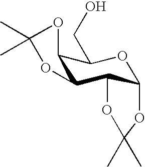 | 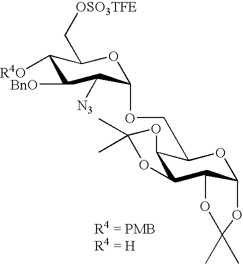 | AgClO₄ (2.0) Cp₂ZrCl₂ (2.0) | 71% α only |
| 2 | 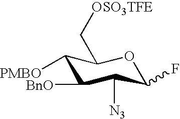 | 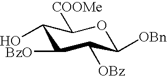 | 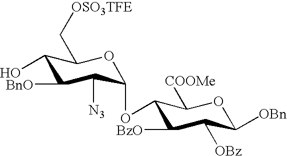 | AgClO₄ (2.0) Cp₂ZrCl₂ (2.0) | 50% α only |
| 3 | 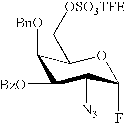 | 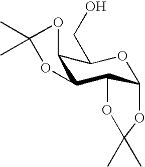 | 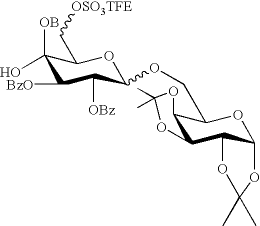 | AgClO₄ (3.0) Cp₂ZrCl₂ (3.0) | 64% α:β 4:1 |

| | | | | |
|---|---|---|---|---|
| 4 | 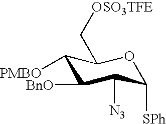 | 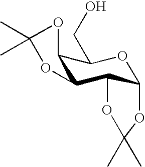 | 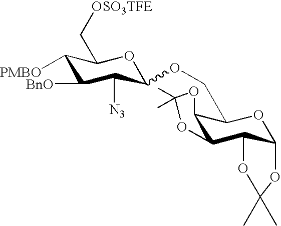 | 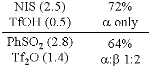 |

| | | | | | |
|---|---|---|---|---|---|
| 5 | 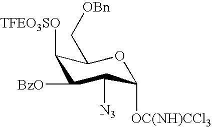 | 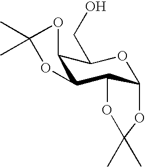 | 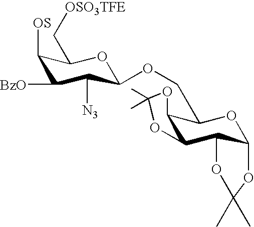 | BF₃.Et₂O (0.45) | 49% β only |
| 6 | 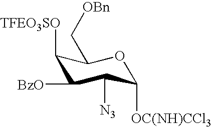 | 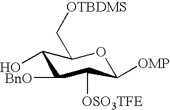 | 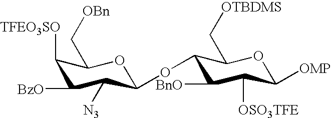 | BF₃.Et₂O (0.2) | 10% β only |

| 7 | 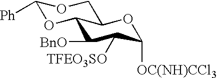 | 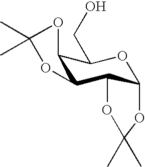 | 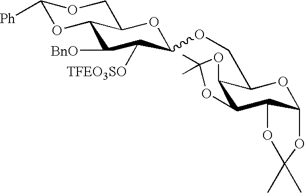 | 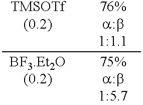 | |
|---|---|---|---|---|---|
| 8 | 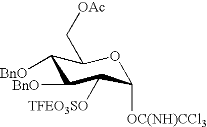 | 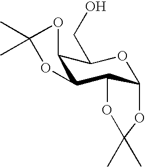 | 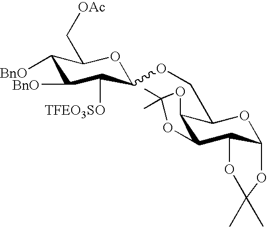 | 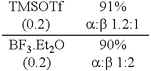 | |
| 9 | 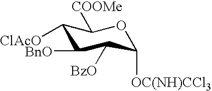 | 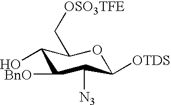 | 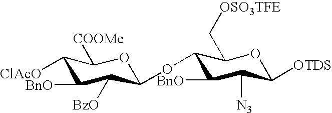 | TMSOTf (0.25) | 44% β only |

Acceptor 71 was prepared as described in the literature (Karst, N., Islam, T., Linhardt, R. J., Org. Lett., 2003, 5, 4839-4842). Acceptor 72 was prepared from known methyl (benzyl 2,3,4-tri-O-acetyl-β-D-glucopyranoside)uronate (Tanaka M., Okita M., Yanatsu I., Carbohydr. Res., 1993, 241, 81-88). All glycosylation reaction were carried on in DCM, except for entry 6 conducted in toluene, and with one equivalent of donor and excess acceptor (1.2-1.5 equiv.) except where otherwise specified. For entry 4, DTBMP (3.0 equiv.) was used as a base, see Codee, J. D. C., Litjens, R. E. J. N., den Heeten, R., Overkleeft, H. S., van Boom, J. H., and van der Marel, G. A., Org. Lett., 2003, 5, 1519-1522.

The strong electron-withdrawing character of the SO₃TFE group was an initial concern in the glycosylation reactions. Its presence contributed to disarm the sugar, and it was expected that the reactivity of both donors and acceptors would be lowered. Glycosylation of reactive acceptor 70, with fluorides, sulfide and imidate donors gave good to excellent results (Table 1, entries 1-5, 7-8). Partial loss of the PMB protection was observed under AgClO₄/Cp₂ZrCl₂ initiation used with the fluoride donor (Table 1, entry 1). The use of acid scavenger, norbornylene, (Gildersleeve, J., Smith, A., Sakurai, K., Raghavan, S., Kahne, D., J. Am Chem. Soc., 1999, 121, 6176-6182) did not improve the outcome of the reaction. In the case of the sulfide (Table 1, entry 4), activation under the traditional NIS/TfOH conditions using 0.5 eq. of catalyst (Konradsson, P., Udodong, U. E., Fraser-Reid, B., Tetrahetron Lett., 1990, 31, 4313-4316) was complete in less than 30 min. However, when the amount of catalyst was decreased (0.2 eq.), the overnight reaction was incomplete and a large amount of unreacted donor was recovered. The use of less reactive acceptors, such as 4-OH containing GlcAp methyl ester 72 or 2-SO₃TFE Glcp derivative 35, resulted in a drop of reactivity, low to poor yields and the recovery of a large amount of unreacted acceptors (Table 1, entries 2 and 6). This trend was confirmed by glycosylation studies with donor 73, prepared as described in literature, (Karst, N., Jacquinet, J.-C., Eur. J. Org. chem., 2002, 815-825) and acceptor 71, affording the disaccharide of entry 9 in Table 1 in a modest 44% yield. Glycosylation performed with 2-SO₃TFE donors 59 and 60 under TMSOTf conditions resulted in a equal amount of products in the α-and \overline{β}anomeric form. Lowering the reaction temperature (−15° C.) did not improve stereo selectivity, suggesting that SO₃TFE group at the 2-position acted as a non-participating group. An increase of the β-selectivity could, however, be achieved using BF₃.Et₂O as a catalyst (Table 1, entries 7 and 8).

### Example 23

Preparation of Representative Polysaccharides of the Invention

Deprotection of compound 32, and the disaccharides of entries 2, 5, and 6 of Table 1 is illustrated in FIG. 15. The 2-sulfo protected monosaccharide 32 was deprotected using standard conditions, t-BuO⁻K⁺/t-BuOH affording 82% yield of A. Similar conditions proved too harsh resulting in decomposition of the 4-sulfo protected disaccharide, entry 5 of Table 1. The use of milder conditions, 1 eq. sodium methoxide/methanol, afforded B yield of 70%. Deprotection of the 6-sulfo compound, entry 2 of Table 1, also posed the greatest challenge, as the major product formed on treating this compound under standard conditions (Proud, A. D., Prodger, J. C., Flitsch, S. L., Tetrahedron Lett., 1997, 38, 7243-7246) was desulfonated. Removal of the OBz groups in this compound, followed by standard deprotection conditions resulted in only minor loss of sulfo group, affording C in 60% yield. To remove the 2- and 4-sulfo groups from the disaccharide of entry 6 in Table 1, a stepwise approach was required. Standard conditions as referenced above resulted in 4-sulfo group deprotection affording D, followed by sodium methoxide/methanol to deprotect the 2-sulfo group. The 2,4-disulfo product E was obtained in a 45% overall yield with concomitant loss of the 6-OTBDMS and OMP protecting groups.

### Example 24

Preparation of Disaccharide Building Blocks Having 4-Sulfo Protection for use as Chiral Synthons for the Synthesis of Chondroitin Sulfate, Dermatan Sulfate or Chondroitin/Dermatan Sulfate Hybrid Tetrasaccharides or Higher Oligosaccharides

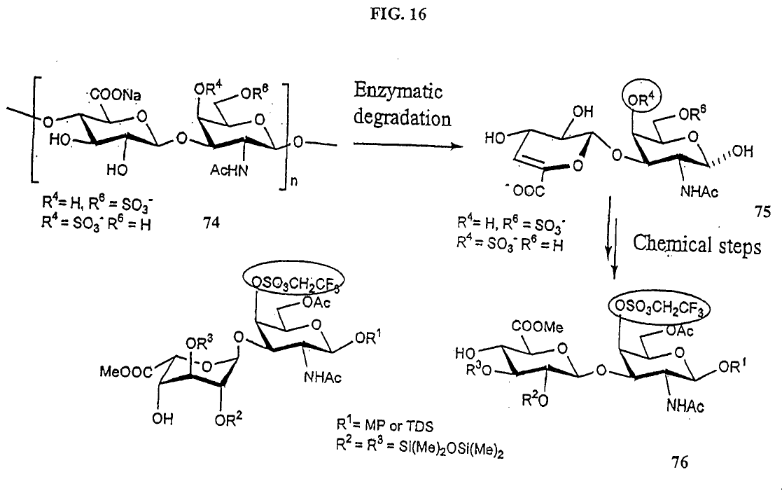

FIG. 16 shows the approach used to prepare disaccharide building blocks having 4-sulfo protection for use as chiral synthons for the synthesis of chondroitin sulfate, dermatan sulfate or chondroitin/dermatan sulfate hybrid tetrasaccharides or higher oligosaccharides. In this synthesis starting from unsaturated sulfated disaccharide, the sulfo protection strategy allows for keeping the positions differentiated, thus avoiding intensive protecting group manipulations. This strategy begins with the enzymatic degradation of chondroitin sulfate or dermatan sulfate polysaccharides 74 using chondroitin ABC lyase. This results in unsaturated disaccharides 75 having sulfo groups in either the 4- or 6- position of the 2-acetyl galactose residue. Separation by ion exchange chromatography can afford the pure 4-sulfo containing unsaturated disaccharide that can be sulfo protected, hydroxyl protected, carboxyl protected and the unsaturated uronic acid can be hydrated in a regio- and stereo-selective manner to obtain a dermatan sulfate disaccharide chiral synthon 76 having an iduronic acid or a chondroitin sulfate disaccharide chiral synthon containing a glucuronic acid.

### Example 25

Preparation of Unsaturated Chondroitin 4-Sulfate Disaccharide into the Protected Bromohydrin Precursor of the Epoxide Used to Prepare Both Glucuronic and Iduronic Acid Containing Chiral Synthons

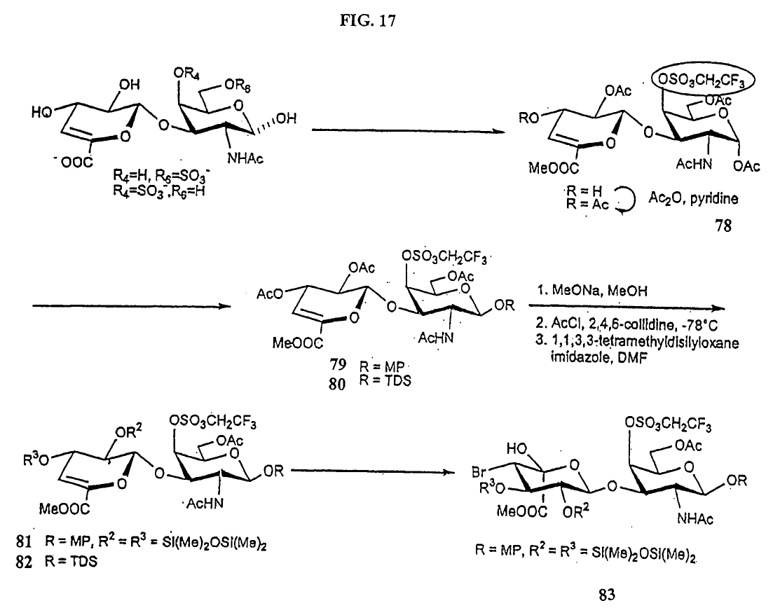

FIG. 17 illustrates the conversion of unsaturated chondroitin 4-sulfate disaccharide into the protected bromohydrin precursor of the epoxide used to prepare both glucuronic and iduronic acid containing chiral synthons. Beginning with a mixture of unsaturated 4- and 6-sulfated chondroitin disaccharides 77 obtained from the chondroitin ABC lyase treatment of chondroitin sulfate, ion exchange chromatography on strong anion exchange high performance liquid chromatography using sodium chloride gradient (0-0.2 M) elution afforded the pure 4-sulfated, unsaturated chondroitin disaccharide as the sodium salt. This disaccharide is converted to its protonic form using Dowex H⁺is neutralized with tetrabutylammonium hydroxide to obtain the tetrabutylammonium salt. Acetic anhydride in pyridine is used to acetylate all of the hydroxyl groups. The carboxyl group is protected as the methyl ester is treated with ClCOOMe/pyridine in methylene chloride. Sulfo protection by treatment with CF₃CH₂N₂ in acetonitrile followed by Ac₂O/pyridine yields the fully protected unsaturated donor 78 in 15% yield over 3 synthetic steps. Deprotection of the anomeric position with hydrazine/acetic acid in dimethylformamide at 50° C., activation as the trichoroacetimidate with trichloroacetonitrile/DBU in methylene chloride and glycosylation with p-methyoxyphenol using TMS triflate catalyst in methylene chloride containing 4 Å molecular sieves or TDS protection of the anomeric hydroxyl group with TDSCl/imidazole in dimethylformamide afforded the MP glycoside 79 (10% over 3 steps) or the TDS glycoside 80 (35% over 2 steps). De-O-acetylation, TMDS protection of the 2,3-hyroxyl groups in the unsaturated uronate residue and reacetylation of the 6-hydroxyl group afforded the appropriately protected OMP glycoside 81 or TDS glycoside 82 in 35% yield over 3 steps. Addition of NBS in tetrahydrofuran in the presence of water afforded the bromohydrin of the OMP glycoside 83. Cyclization of the bromohydrin to the epoxide followed by regio- and stereo-selective reductive opening will afford the disaccharide synthons containing glucuronic or iduronic acid residues.

All publications, patents, and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

1. A method of preparing a sulfo-protected polysaccharide comprising reacting at least one saccharide with at least one other saccharide having a hydroxyl or amine protected with a haloalkyl sulfonyl group to form the sulfo-protected polysaccharide.

2. The method according to claim 1, wherein at least one monosaccharide has an amine functional group protected with a haloalkyl sulfonyl group.

3. The method according to claim 1, wherein at least one monosaccharide has a hydroxyl functional group protected with a haloalkyl sulfonyl group.

4. The method according to claim 1 wherein the haloalkyl sulfonyl group is CF₃CH₂SO₃—

5. The method according to claim 1 further comprising reacting the sulfo-protected polysaccharide with at least one monosaccharide or polysaccharide to provide another polysaccharide.

6. The method according to claim 1 further comprising removing one or more haloalkyl groups from the haloalkyl sulfonyl groups to provide the corresponding sulfo substituted polysaccharide.

7. The method according to claim 1 further comprising removing one or more haloalkyl sulfonyl groups from the polysaccharide to provide the corresponding unprotected polysaccharide.

8. A polysaccharide made by the method according to claim 1.

9. A method of making a polysaccharide comprising reacting a monosaccharide with the polysaccharide of claim 8.

10. A compound comprising a nitrogen-containing monosaccharide having at least one hydroxyl or amine functional group protected by a haloalkyl sulfonyl group.

11. The compound according to claim 10, wherein the monosaccharide is an amino-containing monosaccharide.

12. The compound according to claim 10, wherein the monosaccharide is an azide containing monosaccharide.

13. The compound according to claim 10 wherein the haloalkyl sulfonyl group is CF₃CH₂SO₃—.

14. A method of making a sulfo protected monosaccharide comprising sulfonating a nitrogen-containing monsaccharide to form a sulfonated monosaccharide, and alkylating the sulfonated monosaccharide with a haloalkyl group to form the sulfo protected monosaccharide.

15. The method according to claim 14, wherein the monosaccharide is sulfonated with Me₃NSO₃.

16. The method according to claim 14, wherein the sulfonated monosaccharide is alkylated with CF₃CH₂N₂.

17. The method according to claim 14 wherein the sulfo protected monosaccharide is formed in the presence of a mild acid.

18. The method according to claim 17, wherein the mild acid is citric acid.

19. A polysaccharide comprising at least one haloalkyl sulfonyl group.

20. The polysaccharide according to claim 19, wherein the polysaccharide is heparan, heparan derivatives, glycosaminoglycans, glycosaminoglycan derivatives, or combinations thereof.

21. The polysaccharide of claim 19 wherein the haloalkyl sulfonyl group is CF₃CH₂SO₃−.
